(19) United States
(12) Patent Application Publication
(10) Pub. No.: US 2026/0030035 A1
(43) Pub. Date: Jan. 29, 2026

(54) POWER BUDGETING AND MANAGEMENT FOR PERIPHERAL DEVICES OF DATA PROCESSING SYSTEMS

(71) Applicant: Dell Products L.P., Round Rock, TX (US)

(72) Inventors: SHIVA KUMAR SAMSHETTY, Bangalore (IN); SANDESH HADHIMANE BALAKRISHNA, Bangalore (IN); SANDEEP KUMAR AKULA, Bangalore (IN); SMRUTI RANJAN DEBATA, Bangalore (IN)

(21) Appl. No.: 18/785,417

(22) Filed: Jul. 26, 2024

(51) Int. Cl. G06F 9/4401; G06F 1/3215

(52) U.S. Cl. CPC G06F 9/4411; G06F 1/3215

(57) ABSTRACT

Methods and systems for managing a data processing system are disclosed. A management controller installed within the data processing system that operates independently from a central processing unit (CPU) (e.g., a motherboard) of the data processing system may generate a power usage history snapshot of the data processing system. The power usage history snapshot may be used to determine whether peripheral devices to be installed within the data processing system can be installed without causing any issues to the data processing system. Remedial measures may also be automatically taken by the management controller when the management controller determines that an installed peripheral device is incompatible with the data processing system's platform power budgeting limits.

### FIELD

Embodiments disclosed herein relate generally to device management. More particularly, embodiments disclosed herein relate to systems and methods to manage power use and availability in data processing systems.

### BACKGROUND

Computing devices may provide computer implemented services. The computer implemented services may be used by users of the computing devices and/or devices operably connected to the computing devices. The computer implemented services may be performed with hardware components such as processors, memory modules, storage devices, and communication devices. The operation of these components and the components of other devices may impact the performance of the computer implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with one or more embodiments.

FIG. 1B shows a block diagram illustrating a data processing system in accordance with one or more embodiments.

FIG. 1C shows a block diagram illustrating a management controller in accordance with one or more embodiments.

FIGS. 2A-2C show data flow diagrams in accordance with one or more embodiments.

FIGS. 3A-3C show flowcharts in accordance with one or more embodiments.

FIG. 4 shows a block diagram illustrating a computing device in accordance with one or more embodiments.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

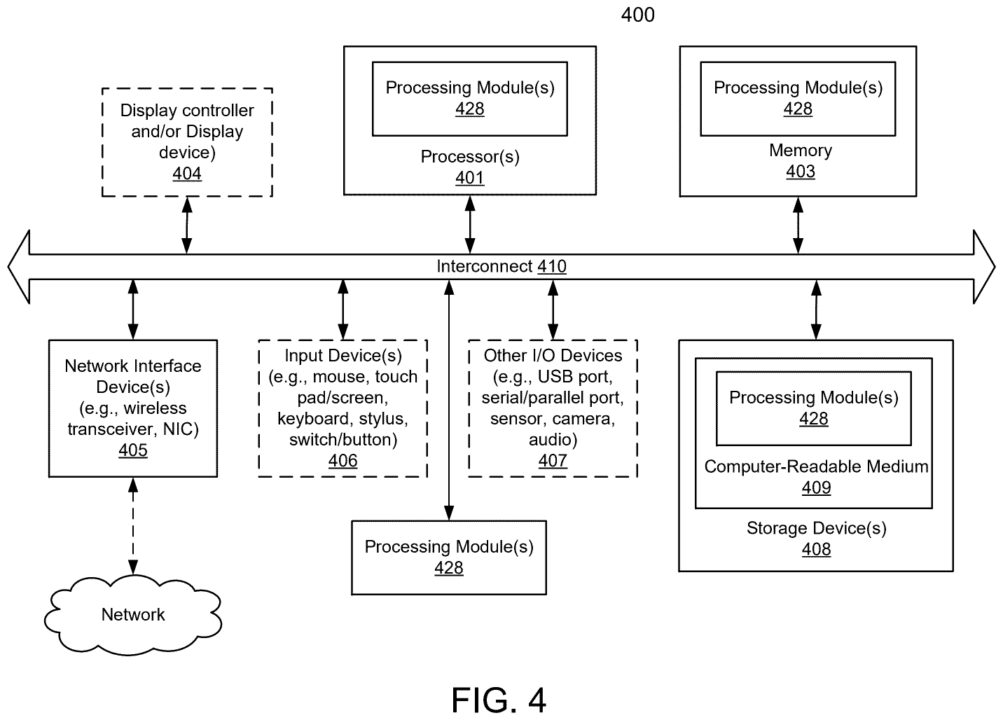

In general, embodiments disclosed herein relate to methods and systems for managing power use and availability in data processing systems. In particular, peripheral devices such as channel cards (e.g., a fiber channel card, or the like), network interface cards (NICs), graphical processing units (GPU), data processing units (DPUs), digital signal processors (DSPs), or the like may be installed into a data processing system (see, e.g., the computing device of FIG. 4). These peripheral devices may all have different power ratings that are unknown to a manufacturer of the data processing system, and may be installed by users (e.g., consumers, customers, or the like) without the manufacturer's knowledge after the data processing system has been shipped from the manufacturer's site.

As a result, it becomes difficult for manufacturers of the data processing system to account for these additionally installed peripheral devices within the data processing system's initial platform power budgeting limits (i.e., how much power can be supplied to components installed within the data processing system by one or more power supply units (PSUs) that come with the data processing system). If these additionally installed peripheral devices do not meet the data processing systems platform power budget limits, these additionally installed peripheral devices may cause negative effects on the data processing systems such as performance degradation, server throttling, overheating, or the like which may lead to additional negative effects such as device downtime and unavailability.

Said another way, if a user installs a peripheral device that will draw (e.g., use) more power than a data processing system is able to provide and/or handle, the data processing system may cease to work/function as a result of component failure (e.g., PSU failure, CPU overheating, decreased performance by components not getting enough power, or the like). Hardware damages and a voiding of the manufacturer's original warranty may also occur.

However, users are generally not provided (e.g., by the manufacturer, through the Basic Input/Output System (BIOS) of the data processing system, or the like) with information regarding a data processing system's platform power budgeting limits. Users are also generally not provided with information regarding a data processing system's remaining available power. Thus, users have no perception into whether desired peripheral devices may or may not be installed within data processing systems that they have purchased.

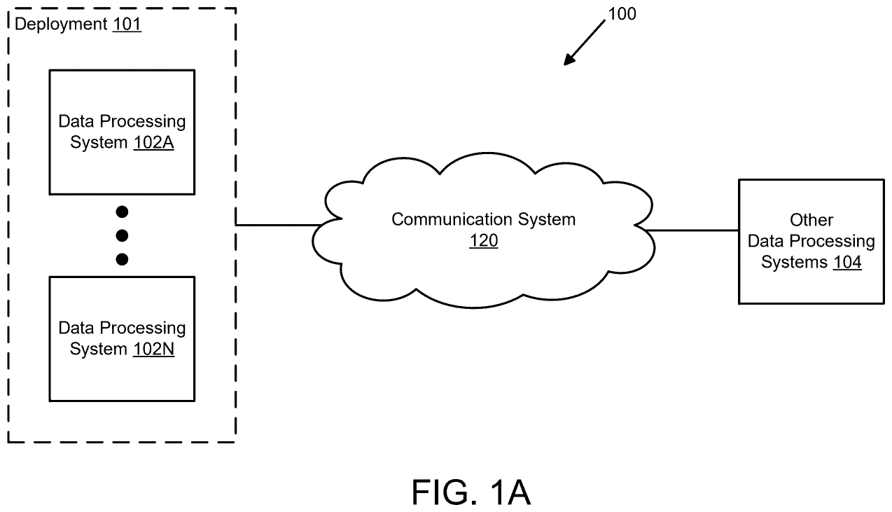

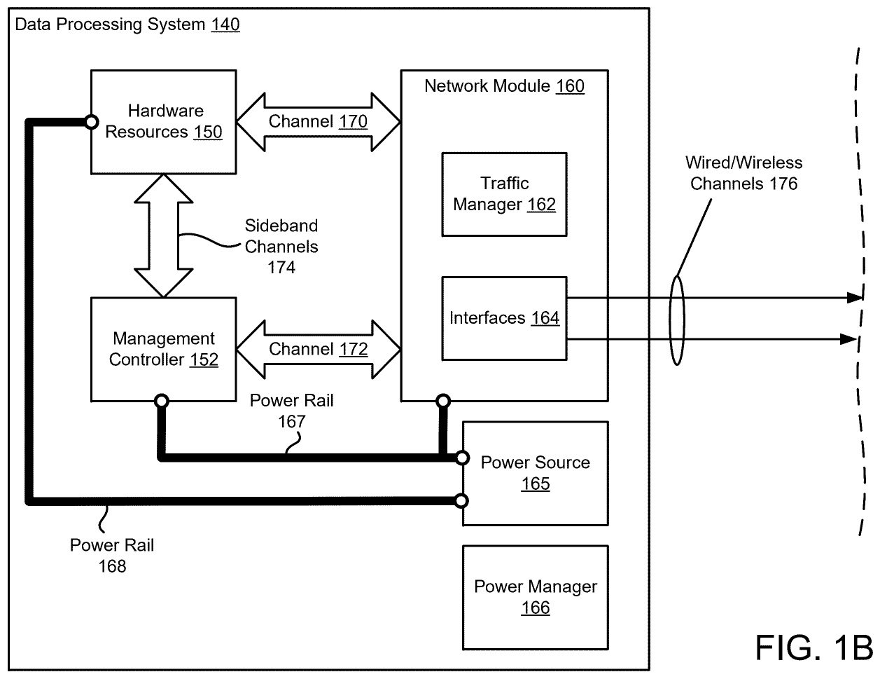

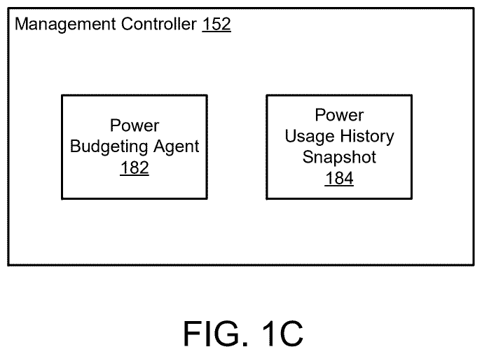

To resolve the above transparency issues regarding power usage and availability of data processing systems, a management controller (e.g., a baseboard management controller (BMC) in the form of a microcontroller, or the like as discussed in more detail before in reference to FIGS. 1B and 1C), may be provided to continuously monitor a data processing system's power usage and available power budget. As a result, when new peripheral devices are being installed (e.g., with or without the power ratings of the new peripheral devices being known beforehand by the data processing system prior to the installation), the management controller may implement one or more actions that advantageously prevent any disruptions to and/or failure of the functions and performance of the data processing system.

For example, if a user provides a peripheral device's power rating to the management controller prior to installing the peripheral device, the management controller may use the power information it has gathered to advise the user regarding the risks of installing the peripheral device. As another example, if a user has already installed a peripheral device without providing the peripheral device's power rating to the management controller prior to the installation, the management controller may automatically retrieve the peripheral device's power ratings and execute performance of one or more remedial actions (also referred to herein as “power usage remediation notifications”) to prevent any disruptions to and/or failure of the functions and performance of the data processing system.

Thus, embodiments disclosed herein may provide, among others an improvement to the above-discussed power usage and availability issues (e.g., an existing technical problem in the present technical field of embodiments disclosed herein) when new hardware components (e.g., the peripheral devices) are installed into one or more data processing systems. By preventing any disruptions to and/or failure of the functions and performance of the data processing system, embodiments disclosed herein also directly improve the functionality (e.g., the computer functionalities) of these data processing systems.

In an embodiment, a method for managing a data processing system is provided. The method may include: obtaining, by a management controller of the data processing system, power data of the data processing system, the power data comprising a total available power of the data processing system; generating, by the management controller, a power usage history snapshot using the power data, the power usage history snapshot storing instances of the total available power of the data processing system obtained over a predetermined period of time; and using, by the management controller, the power usage history snapshot to control installation of one or more peripheral devices into the data processing system.

An average of the instances of the total available power of the data processing system stored in the power usage history snapshot is used as a power budget of the data processing system to control the installation of the one or more peripheral devices.

Using the power usage history snapshot to control the installation of the one or more peripheral devices into the data processing system comprises, for a peripheral device of the one or more peripheral devices and by the management controller: obtaining a power rating of the peripheral device from a user of the data processing system, the peripheral device not yet being installed within the data processing system; comparing the power rating of the peripheral device to the power budget; and providing a notification to the user regarding whether the peripheral device can or cannot be installed into the data processing system without causing a power consumption issue based on a result of the comparing.

Using the power usage history snapshot to control the installation of the one or more peripheral devices into the data processing system comprises, for a peripheral device of the one or more peripheral devices and by the management controller: obtaining a power rating of the peripheral device without user intervention, the peripheral device already being installed in the data processing system before the management controller is aware of the power rating; comparing the power rating of the peripheral device to the power budget; and causing the data processing system to perform one or more power usage remediation actions based on a result of the comparing.

The one or more power usage remediation actions comprises at least one action selected from a group consisting of: providing a warning to a user of the data processing system that the power rating of the peripheral device is incompatible with the power budget of the data processing system, disabling an interface between the data processing system and the peripheral device, disabling an external interface of the data processing system, and preventing completion of a startup of the data processing system.

The power data and the power usage history snapshot are obtained and created, respectively, using one or more daemon threads executing on the management controller.

The management controller is a microcontroller that operates independently of a central processing unit (CPU) of the data processing system.

A non-transitory media may include instructions that when executed by a processor cause the computer-implemented method to be performed.

A data processing system may include the non-transitory media and a processor, and may perform the computer-implemented method when the processor executes the instructions in the non-transitory media.

Turning to FIG. 1A, a block diagram illustrating a system 100 in accordance with an embodiment is shown. The system 100 shown in FIG. 1A may provide computer implemented services. The computer implemented services may include any type and quantity of computer implemented services. For example, the computer implemented services may include data storage services, instant messaging services, database services, and/or any other type of service that may be implemented with a computing device.

To provide the computer implemented services, the system 100 may include any number of data processing systems 102A-102N and other data processing systems104. The data processing systems 102A-102N may be grouped together within one or more deployments 101 (e.g., a server farm, a collection of computing devices within an entity, or the like). Data processing systems 102A-102N may provide the computer implemented services to users of these data processing systems 102A-102N and/or to other devices (e.g., other data processing systems 104 such as a remote server and/or computing device connected to the data processing systems 102A-102N of deployment 101 via communication system 120). Different data processing systems (e.g., any of data processing systems 102A-102N and/or other data processing systems 104) may provide similar and/or different computer implemented services.

To provide the computer implemented services, these data processing systems (e.g., any of data processing systems 102A-102N and/or other data processing systems 104) may include various hardware components (e.g., processors, memory modules, storage devices, etc.) and host various software components (e.g., operating systems, application, startup managers such as basic input-output systems, etc.). These hardware and software components (discussed in more detail below in FIGS. 1B-1C) may provide the computer implemented services via their operation.

Additional hardware components such as peripheral devices including channel cards (e.g., a fiber channel card, or the like), network interface cards (NICs), graphical processing units (GPU), data processing units (DPUs), digital signal processors (DSPs), or the like may also be installed within these data processing systems (e.g., any of data processing systems 102A-102N and/or other data processing systems 104).

However, installation of these peripheral devices may cause issues if these peripheral devices are incompatible with a specific data processing system's (e.g., data processing system 102A) platform power budgeting limits. Said another way, installation of a peripheral device (or peripheral devices) that will use more power than what the data processing system can provide (in addition to the power already being provided to the default hardware components of the data processing system) may cause a failure (e.g., hardware failure, software failure, or both) of the data processing system.

To resolve these power usage and availability (e.g., power limitation) issues, a management controller (e.g., 152 of FIG. 1B) may be installed within the data processing system. The management controller may operate independently from a central processing unit (CPU) (e.g., a motherboard) of the data processing system may generate a power usage history snapshot of the data processing system. The power usage history snapshot may be used to determine whether peripheral devices to be installed within the data processing system can be installed without causing any issues to the data processing system. Remedial measures may also be automatically taken by the management controller when the management controller determines that an installed peripheral device is incompatible with the data processing system's platform power budgeting limits.

The software components may be implemented using various types of services. For example, each data processing system (e.g., any of data processing systems 102A-102N and/or other data processing systems 104) of system 100 may host various services that provide the computer implemented service (e.g., application services) and/or that manage the operation of these services (e.g., management services). The aggregate (e.g., combination) of the management and application services may be a complete service that provide desired functionalities.

Any of the components illustrated in FIG. 1A may be operably connected to each other (and/or components not illustrated) with communication system 120. In an embodiment, communication system 120 includes one or more networks that facilitate communication between any number of components. The networks may include wired networks and/or wireless networks (e.g., and/or the Internet). The networks may operate in accordance with any number and types of communication protocols (e.g., such as the Internet Protocol).

While FIG. 1A is illustrated as including a limited number of specific components, a system in accordance with an embodiment may include fewer, additional, and/or different components than those illustrated therein.

Turning to FIG. 1B, a diagram illustrating data processing system 140 in accordance with an embodiment is shown. Data processing system 140 may be similar to any of the data processing systems (e.g., any one of data processing systems 102A-102N or the other data processing systems 104) shown in FIG. 1A.

To provide computer implemented services, data processing system 140 may include any quantity of hardware resources 150. Hardware resources 150 may be in-band hardware components, and may include a processor operably coupled to memory, storage, and/or other hardware components. These hardware resources 150 (in addition to network module 160, management controller 152, power source 165, power manager 166, and the other components shown in FIG. 1B) may be the default hardware components that are included in the data processing system 140 by a manufacturer of the data processing systems 140. However, it could be appreciated that the default hardware components may include more (or less) of what is shown in FIG. 1B.

The processor (e.g., a central processing unit (CPU) installed on a motherboard, or the like) may host various management entities such as operating systems, drivers, network stacks, and/or other software entities that provide various management functionalities. For example, the operating system and drivers may provide abstracted access to various hardware resources. Likewise, the network stack may facilitate packaging, transmission, routing, and/or other functions with respect to exchanging data with other devices.

For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer implemented services. The applications may utilize various services provided by the management entities and use (at least indirectly) the network stack to communication with other entities.

In embodiments, the processor (of the hardware resources 150) may be a main processor (e.g., the central processing unit (CPU) and motherboard on which the CPU is installed) of the data processing system 140. The processor (of the hardware resources 150), may also be the main processor on which an operating system (OS) of the data processing system 140 is stored and runs.

In embodiments, use of the network stack and the services provided by the management entities may place the applications at risk of indirect compromise. For example, if any of these entities trusted by the applications are compromised, these entities may subsequently compromise the operation of the applications. For example, if various drivers and/or the communication stack are compromised, communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 140) to another device via any number of intermediate networks (e.g., via wired/wireless channels 176 that are part of the networks).

To reduce the likelihood of the applications and/or other in-band entities from being indirectly compromised, data processing system 140 may include management controller 152 and network module 160. Each of these components of data processing system 140 is discussed below.

Management controller 152 may be implemented, for example, using a system on a chip or other type of independently operating computing device (e.g., independent from the in-band components, such as hardware resources 150, of a data processing system 140). For example, management controller 152 may be a baseboard management controller (BMC), or the like.

Management controller 152 may provide various management functionalities for data processing system 140. For example, management controller 152 may monitor various ongoing processes performed by the in-band component, may manage power distribution, thermal management, and/or other functions of data processing system 140. To conduct such monitoring and provide such functions, the management controller 152 may include its own processor (e.g., a second processor separate and operating independently from the main processer of the data processing system).

Additionally, management controller 152 may be operably connected to various components via sideband channels 174 (in FIG. 1B, a limited number of sideband channels are included for illustrative purposes, it will be appreciated that management controller 152 may communication with other components (including peripheral devices installed within the data processing system 140) via any number of sideband channels). The sideband channels may be implemented using separate physical channels, and/or with a logical channel overlay over existing physical channels (e.g., logical division of in-band channels). The sideband channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, to reduce the likelihood of indirect compromise of an application hosted by hardware resources 150, management controller 152 may enable information from other devices to be provided to the application without traversing the network stack and/or management entities of hardware resources 150. To do so, the other devices may direct communications including the information to management controller 152. Management controller 152 may then, for example, send the information via sideband channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similarly, processes may be used to facilitate outbound communications from the applications.

Management controller 152 may be operably connected to communication components of data processing system 140 via separate channels (e.g., 172) from the in-band components, and may implement or otherwise utilize a distinct and independent network stack (e.g., TCP/IP). Consequently, management controller 152 may communication with other devices independently of any of the in-band components (e.g., does not rely on any hosted software, hardware components, etc.). Accordingly, compromise of any of hardware resources 150 and hosted component may not result in indirect compromise of any management controller 152, and entities hosted by management controller 152.

To facilitate communication with other devices, data processing system 140 may include network module 160. Network module 160 may provide communication services for in-band components and out-of-band components (e.g., management controller 152) of data processing system. To do so, network module 160 may include traffic manager 162 and interfaces 164.

Traffic manager 162 may include functionality to (i) discriminate traffic directed to various network endpoints advertised by data processing system 140, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176.

Thus, from the perspective of an external device, the in-band components and out-of-band components of data processing system 140 may appear to be two independent network entities, that may independently addressable, and otherwise unrelated to one another.

To facilitate management of data processing system 140 over time, hardware resources 150, management controller 152 and/or network module 160 may be positioned in separately controllable power domains. By being positioned in these separately power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

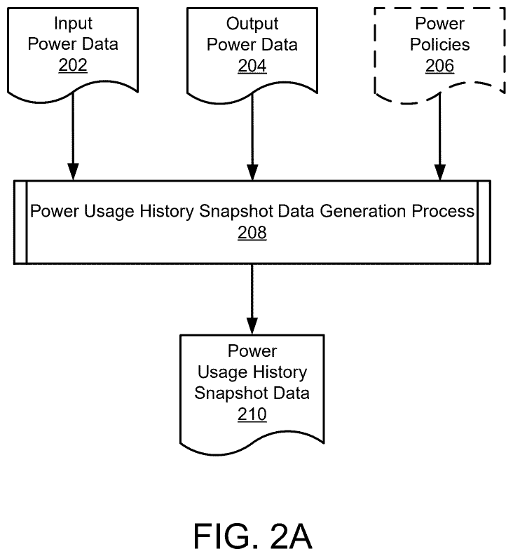

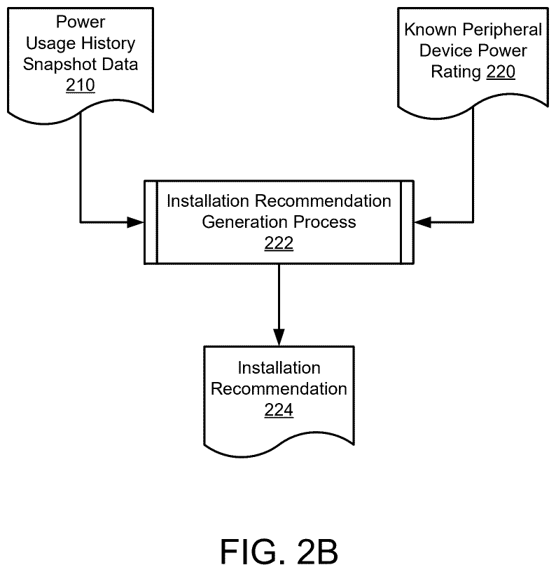

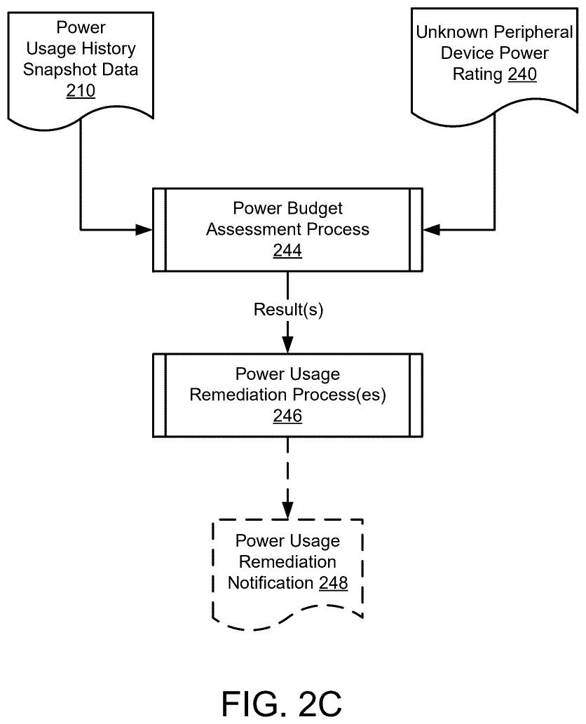

To implement the separate power domains, data processing system 140 may include a power source (e.g., 165) that separately supplies power to power rails (e.g., 167, 168) that power the respective power domains. Power from the power source (e.g., one or more power supplies, batteries, or other types of PSUs etc.) may be selectively provided to the separate power rails to selectively power the different power domains. A power manager (e.g., 166) may manage power from power source 165 that is supplied to the power rails. Management controller 152 may cooperate with power manager 166 to manage supply of power to these power domains. For example, management controller 152 may cooperate with power manager 166 to determine a remaining power budget and/or a remaining power availability of the data processing system (as discussed in more detail below in reference to FIG. 1C and FIG. 2A).

In FIG. 1B, an example implementation of separate power domains using power rails 167-168 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

In addition to the components (e.g., hardware resources 150, network module 160, management controller 152, power source 165, power manager 166, power rails 167-168, components making up channels 170-172 and sideband channels 174, etc.) additional hardware components (e.g., peripheral devices) may be installed within (or externally to) the data processing system.

In embodiments, these peripheral devices may include channel cards (e.g., a fiber channel card, or the like), network interface cards (NICs), graphical processing units (GPU), data processing units (DPUs), digital signal processors (DSPs), or the like and may communicate with the existing components of the data processing system 140 via various interfaces (e.g., one or more Peripheral Component Interconnect Express (PCIe) buses, universal serial buses (USB), or the like).

These peripheral devices may also draw power from the power source 165 in order to provide their functions (e.g., may be powered entirely, or in part, by power supplied from the power source 165 of the data processing system 140). Each of these peripheral devices may have one or more power rating values (e.g., a minimum, average, optimal, maximum, or the like power rating value) (also referred to herein simply as “power rating”) as defined by a manufacturer and/or provider of these peripheral devices.

Turning to FIG. 1C, a diagram illustrating an example of a management controller 152 of data processing system 140 in accordance with an embodiment is shown. As shown in FIG. 1C, the management controller 152 may include a power budgeting agent 182 and a power usage history snapshot 184. Each of these components will be described as follows.

Power budgeting agent 182 may be configured using hardware, software, or a combination of both. For example, power budgeting agent 182 may be a daemon thread (e.g., a low priority daemon job) executing on one or more hardware components of the management controller 152. Power budgeting agent 182 may be configured to gather power data (e.g., via power manager 166 and other components of the data processing system 140 of FIG. 1B) including input power data, output power data, and/or one or more power policies of the data processing system 140.

The input power data may be a quantity of the total power being provided into the PSU(s) making up the power source 165 of data processing system 140 from one or more external power sources (e.g., wall outlets, generators, batteries, or the like) connected to the PSU(s) making up power source 165. This input power data may include input power measured at one or more inputs of the power source 165.

The output power data may be a quantity of the total power being provided by the power source 165 (via one or more of the PSUs making up the power source 165) to power all of the components installed and running within the data processing system 140 (e.g., all of the components shown in FIG. 1B). This output power data may include output power measured at one or more outputs of the power source 165.

The power policies of the data processing system 140 may include one or more power usage/supply policies (or the like) defined by a user (e.g., current owner, manufacturer, or the like) of the data processing system 140. The power policies may include any number or type of policies regarding how the components of the data processing system 140 is receiving or being supplied with power from the power source 165. For example, assume that the power source 165 includes two PSUs, the power policies may specify (e.g., indicate) that one of the PSUs is only to be used for redundant purposes (e.g., when the other PSU fails) and not to be used simultaneously with the PSU. As another example, assume that the power source 165 includes only a single PSU, the power policies may specify (e.g., indicate) a maximum amount of (e.g., a limit for) power that can be output from the single PSU. More specifically, to prevent overheating, the single PSU may be limited to output only 95% (or the like) of the amount of the maximum power it is designed to output.

Other power-related limitations, definitions, or the like may be specified within the power policies without departing from the scope of embodiments disclosed herein.

Power budgeting agent 182 may also be configured to use such gathered power data to calculate a total available power of the data processing system. In embodiments, this total available power may be calculated by subtracting a total input power (also referred to herein as “P-IN”) (e.g., from the input power data) from a total output power (also referred to herein as “P-Out”) (e.g., from the output power data) at a given point in time. For example, assume that P-IN at 3:31 PM of May 30, 2024 is 75 W and P-Out at the same time and date is 50 W. The total available power at 3:31 PM of May 30, 2024 will be 25 W.

In embodiments, the calculations by the power budgeting agent 182 may also take any (or all) of the power policies into consideration. For example, assume that the power source 165 includes two PSUs where one PSU is used only for redundant purposes. The P-IN recorded in this example would only be the P-IN for the single PSU (among the two PSUs) that is working as the main (and not the backup) PSU. Said another, the P-IN in this example would not be a sum of the input power into both (the main and the backup) PSUs.

Power budgeting agent 182 may also be configured to use such gathered (e.g., P-IN, P-Out, etc.) and calculated power data (e.g., the total available power, or the like) to control installation of one or more peripheral devices into the data processing system. This will be described in more detail below in reference to FIGS. 2A-2C.

Additionally, power budgeting agent 182 may also be configured to store such gathered (e.g., P-IN, P-Out, etc.) and calculated power data (e.g., the total available power, or the like) in a power usage history snapshot 184.

Similar to power budgeting agent 182, the power usage history snapshot 184 may also be configured as hardware, software, or a combination of both. For example, the power usage history snapshot 184 may be another daemon thread (e.g., a low priority daemon job) executing on one or more hardware components of the management controller 152.

The power usage history snapshot 184 may be configured to maintain a snapshot (e.g., in the form of a data structure such as a time series list or the like) of a power usage history of the data processing system 140 (e.g., how much power is used by all of the components installed within the data processing system 140 (including any installed peripheral devices) at any given moment).

Depending on the frequency at which the power budgeting agent 182 is configured to gather and calculate the power data, the power usage history snapshot 184 may be configured to store the data at the same frequency. For example, assume that the power budgeting agent 182 is configured to collect and calculate data every one (1) second, the power usage history snapshot 184 may include one (1) second interval entries for such collected/calculated data. The frequency at which the power budgeting agent 182 and power usage history snapshot 184 collects, calculates, and stores power data may be preset by a user (e.g., an administrator, manager, or the like) of the management controller 152 and/or the data processing system 140. The frequency can also be set at any non-negative number at any unit of time (e.g., 1 second, 1 millisecond, 1 minute, 5 minutes, 10 minutes, 1 week, or the like) without departing from the scope of embodiments disclosed herein.

The power usage history snapshot 184 may also be configured to manage the capacity of the data structure storing such power data. For example, assume that only a limited amount of computing resources (e.g., memory) is allocated to the power usage history snapshot 184 for maintaining the power data such as, but not limited to, 500 megabytes (Mb). As this limit is being reached (e.g., as the power usage history snapshot 184 is storing up to 500 Mb of power data), the power usage history snapshot 184 may be configured (e.g., based on one or more storage rules and policies set by the user) to manage the power data. For example, the power usage history snapshot 184 may manage the power data in a time scaled repository structure and may aggregate one or more entries within the structure to restrict the size of such structure.

For example, one or more storage rules and policies set by the user may force the power usage history snapshot 184 to aggregate n number of entries into an average value across the time spanning between the n number of entries. Said another way, sixty (60) one (1) second entries may be aggregated into a single one (1) minute entry showing the average power data (e.g., average P-IN, average P-Out, average total available power) within that one minute encompassing the sixty (60) one (1) second entries, or the like. The way and manner that the data stored within the time scaled repository structure managed by the power usage history snapshot 184 may be configured in any way by the user without departing from the scope of embodiment disclosed herein as long as the one or more storage rules and policies prevent an overuse of the limited computing resources allocated to the power usage history snapshot 184 (e.g., using more than the example 500 Mb allocated to the power usage history snapshot 184).

Although not shown in FIG. 1C, management controller may also include other components such as its own set of hardware components (e.g., the second processor, one or more memories that are independent and separate from the memor(ies) of the data processing system 140, or the like) and its own set of software components (e.g., a set of applications independent and separate from the applications running on the other components of the data processing system 140 of FIG. 1B). Additionally, management controller 152 may maintain any number of power usage history snapshots 184, as configured (e.g., via one or more policies set) by a user (e.g., an administrator) of the management controller 152 directly through the data processing system 140 (e.g., inputting commands to the main processor that are then routed to the management controller 152, or the like) or indirectly via one or more remote devices (e.g., other data processing systems 104 of FIG. 1A configured as a data processing system manager such) that are configured to remotely control and/or manage (e.g., the capabilities, functionalities, or the like) the data processing system 140.

Additionally, although the power budgeting agent 182 and the power usage history snapshot 184 are discussed above as two separate components, the functionalities of the power budgeting agent 182 and power usage history snapshot 184 may be performed by a single component (e.g., a single module, a single daemon thread, or the like) or by more than two components without departing from the scope of embodiments disclosed herein.

In summary, the power budgeting agent 182 and the power usage history snapshot 184 keeps a record of power usage snapshots (e.g., a power budget table), facilitated by the interactions between management controller 152 and power manager 166, by calculating input and output power consumed by the data processing system 140 with the components currently installed within the data processing system 140. This record of the power usage snapshots (e.g., the power budget table) may be updated whenever any components are installed into or removed from the data processing system 140.

To further clarify embodiments disclosed herein, data flow diagrams in accordance with one or more embodiments disclosed herein are shown in FIGS. 2A-2C. In these diagrams, flows of data and processing of data are illustrated using different sets of shapes. A first set of shapes (e.g., 202, 204, 206, 182, etc.) is used to represent data structures, and a second set of shapes (e.g., 208, 222, 246, etc.) is used to represent processes performed using and/or that generate data.

As shown in FIG. 2A, a first data flow diagram illustrating power usage history snapshot data generation process of embodiments disclosed herein is provided. As discussed above in reference to FIG. 1C, input power data 202, output power data 204, and power policies 206 (if any are set by a user of the management controller 152 or data processing system 140 of FIG. 1B) may be gathered (e.g., by power budgeting agent 182 of FIG. 1C).

As also discussed above in reference to FIG. 1C, the input power data 202, output power data 204, and power policies 206 may be provided to power usage history snapshot data generation process (e.g., executed/performed by power budgeting agent 182 of FIG. 1C) to generate (e.g., create) the power usage history snapshot data 210 (e.g., maintained by power usage history snapshot 184 of FIG. 1C).

Turning now to FIG. 2B, a second data flow diagram illustrating a process for managing a data processing system of one or more embodiments is provided. As shown in FIG. 2B, the power usage history snapshot data 210 (e.g., generated in FIG. 2A) is obtained. Additionally, a known peripheral device power rating 220 is also obtained.

The known peripheral device power rating 220 may be a power rating of a peripheral device obtained by a user from, for example, a user manual, documentation, or the like of the peripheral device. This peripheral device (or peripheral devices) may be one that the user wishes to install within a data processing system (e.g., data processing system 140 of FIG. 1B).

The known peripheral device power rating 220 may be provided by the user to the management controller (e.g., management controller 152 of FIGS. 1B and 1C) via a graphical user interface (GUI) displayed to a user on a display (connected or external) of the data processing system. The known peripheral device power rating 220 may be provided via the GUI before the peripheral device associated with the known peripheral device power rating 220 is actually installed in (or on) the data processing system.

Said another way, before a user installs a peripheral device into (or on) a data processing system, the user can find the power rating of the peripheral device in the peripheral device's manual, documentation, or the like, and provide that power rating to the management controller.

The known peripheral device power rating 220 and the power usage history snapshot data 210 may be provided to installation recommendation generation process 222 to generate an installation recommendation 224 for the peripheral device (or devices) the user wishes to install and eventually use.

As part of installation recommendation generation process 222, the power rating included in the known peripheral device power rating 220 may be compared to the total available power of the data processing system included in the power usage history snapshot data. A decision may then be made by comparing these two values to determine whether the peripheral device the user wishes to install is compatible with the data processing system's platform power budgeting limits.

For example, assume that the total available power of the data processing system is 10 W and the power rating of the peripheral device is 20 W, a decision may be made (e.g., by power budgeting agent 182 of FIG. 1C and as discussed above in reference to FIG. 1C), that the peripheral device cannot be installed because its power rating exceeds the total available power of the data processing system. As another example, assume that the total available power of the data processing system is 20 W and the power rating of the peripheral device is 10 W, a decision may be made that the peripheral device can be installed because its power rating does not exceed the total available power of the data processing system.

In embodiments, the total available power used by the installation recommendation generation process 222 may be an average of multiple instances of the total available power included in the power usage history snapshot data 210. For example, the installation recommendation generation process 222 may take an average total available power over a period of time (e.g., 1 day, or any other period preset by a user) and use the average total available power in the above-discussed determination. This advantageously allows the user to adjust (e.g., lower, increase, or the like) the power consumption of other components currently installed within the data processing system 140 (e.g., by stopping certain processes that are running, or the like) to ensure that the peripheral device the user wishes to install can meet the power budget of the data processing system 140. Alternatively, the total available power may be the total available power at the exact time (or within a predetermined range of time) that the user wishes to install the peripheral device.

In embodiments, the decision (e.g., by the power budgeting agent 182), the average total available power, and other data included in the power usage history snapshot data may be presented to the user in the installation recommendation 224. The installation recommendation may include any and all information (e.g., from the power usage history snapshot data 210, from the known peripheral device power rating 220, and any data generated by the power budgeting agent 182 using these two sets of data) that would allow the user to make an informed decision as to whether the peripheral device can be installed into (or on) the data processing system 140 without causing any disruptions to and/or failure of the functions and performance of the data processing system.

Turning now to FIG. 2C, a third data flow diagram illustrating a process for managing a data processing system of one or more embodiments is provided. As shown in FIG. 2C, the power usage history snapshot data 210 (e.g., generated in FIG. 2A) is obtained. Additionally, an unknown peripheral device power rating 240 is also obtained.

The unknown peripheral device power rating 240 may include the power rating(s) of peripheral device(s) already installed into the data processing system without previously assessing (as in the process of FIG. 2B) whether the peripheral device(s) are compatible or incompatible with the platform power budgeting limit of the data processing system. Said another way, the peripheral device(s) are installed before assessing whether the data processing system has the power budget for these peripheral device(s).

The power rating(s) included in the unknown peripheral device power rating 240 may be obtained by the management controller directly from the already installed peripheral device(s) (e.g., via the sideband channels 174 of FIG. 1B) or remotely from another source (e.g., the Internet, a remote computing device, or the like) after the management controller has obtained configuration data (e.g., device identification (ID) data including a serial number, or the like) of the peripheral device(s).

In embodiments, the unknown peripheral device power rating 240 may also be obtained (e.g., by the power budgeting agent 182) by comparing data included in the power usage history snapshot data 210. For example, if the power budgeting agent 182 is able to determine when (e.g., an approximate data and time that) the peripheral device(s) were installed, the power budgeting agent 182 may look at the history of the P-Out values in the power usage history snapshot data 210 to approximate the power rating(s) of the already installed peripheral device(s).

Said another way, the power rating(s) of the already installed peripheral device(s) may be obtained (e.g., by the management controller) without any user intervention, and the peripheral device(s) were already installed before the management controller is aware of the power rating(s).

Other methods and techniques that can be used to accurately obtain the power rating(s) of the already installed peripheral device(s) not discussed above may also be used without departing from the scope of embodiments disclosed herein.

The unknown peripheral device power rating 240 and the power usage history snapshot data 210 may be provided to a power budget assessment process 244. Similar to the installation recommendation generation process 222 discussed above in reference to FIG. 2B, the power budget assessment process 244 may be configured to determine whether the power rating(s) of the already installed peripheral devices are incompatible with the platform power budgeting limit of the data processing system. Said another way, the power budget assessment process 244 may be configured to determine whether the already installed peripheral device(s) will cause any disruptions to and/or failure of the functions and performance of the data processing system if they are not taken out (e.g., uninstalled) within a predetermined period of time (e.g., immediately, within 10 minutes, within 1 hour, within a day, or the like) and/or if the user does not adjust (e.g., lower, increase, or the like) the power consumption of other components currently installed within the data processing system.

The results of the power budget assessment process 244 may be provided to power usage remediation process(es) 246 that is configured to cause the management controller and/or the data processing system to perform one or more actions (e.g., processes) to remediate any excessive power usage by the already installed peripheral device(s).

For example, a first action taken by the power usage remediation process(es) 246 may be to provide a power usage remediation notification 248 to the user (e.g., via a pop-on screen on the GUI or as a lifecycle controller log message, or the like, on the display of the data processing system). As another example, a second action taken by the power usage remediation process(es) 246 may be to cause the BIOS of the data processing system (e.g., by the management controller) to safely disable any connections (e.g., PCIe function on a PCIe bus, or the like) between the data processing system and the already installed peripheral device(s). This second action may advantageously prevent the data processing system from power throttling, which may cause disruptions to and/or failure of the functions and performance of the data processing system.

As yet another example, a third action taken by the power usage remediation process(es) 246 may be to cause the data processing system to disable (e.g., by the management controller) any ports (internal or external) (e.g., network ports, or the like) associated with the already installed peripheral device(s) (e.g., a network device such as a NIC or the like in such an instance) to stop any processes being performed by the already installed peripheral device(s) using such ports. This third action may advantageously prevent the data processing system from power throttling, which may cause disruptions to and/or failure of the functions and performance of the data processing system.

As yet another example, a fourth action taken by the power usage remediation process(es) 246 may be to prevent completion of a startup of the data processing system. For example, if the already installed peripheral device(s) were installed while the data processing system is powered off, the management controller (e.g., via power budgeting agent 182) may determine (before or even while) the data processing system is starting up (e.g., just being powered on) that the already installed peripheral device(s) are incompatible with the available power budget. Because the management controller can receive power even while the data processing system is powered off, the management controller may make this determination before the data processing system is powered on. While the data processing system is starting up, the management controller may prevent (e.g., via power budgeting agent 182) the BIOS of the data processing system from booting the host operating system until the detected power usage issues are remediated. In embodiments, the user of the data processing system may configure the management controller and BIOS such that this prevention of the booting of the host operating system may be overridden by the user at the time of the startup.

Other actions not discussed above that would prevent disruptions to and/or failure of the functions and performance of the data processing system by the already installed peripheral device(s) may also be utilized without departing from the scope of embodiments disclosed herein.

Additionally, any combination of the above example actions may be performed by the power usage remediation process(es) 246 without departing from the scope of embodiments disclosed herein. For example, the power usage remediation notification 248 may first be provided to the user and, if no actions by the user are detected within a predetermined period of time, the second action of causing the BIOS to safely disable the PCIe function of the already installed peripheral device(s) may be implemented.

Any of the processes illustrated using the second set of shapes (shown in FIGS. 2A-2C) may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

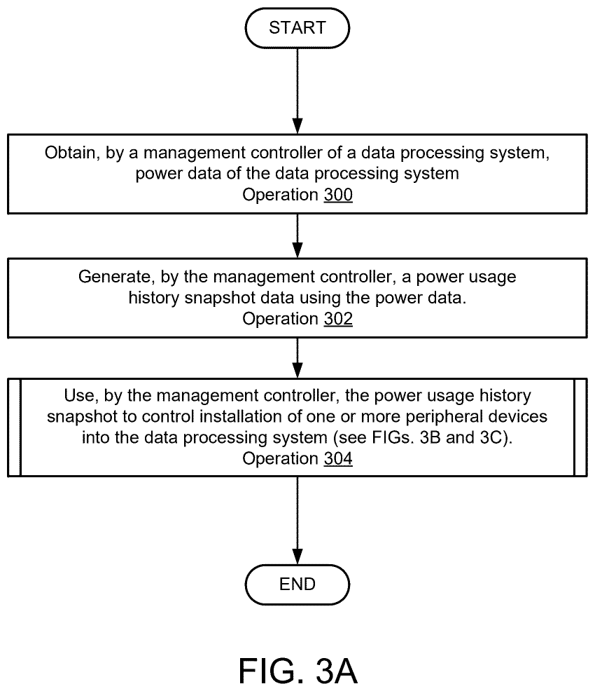

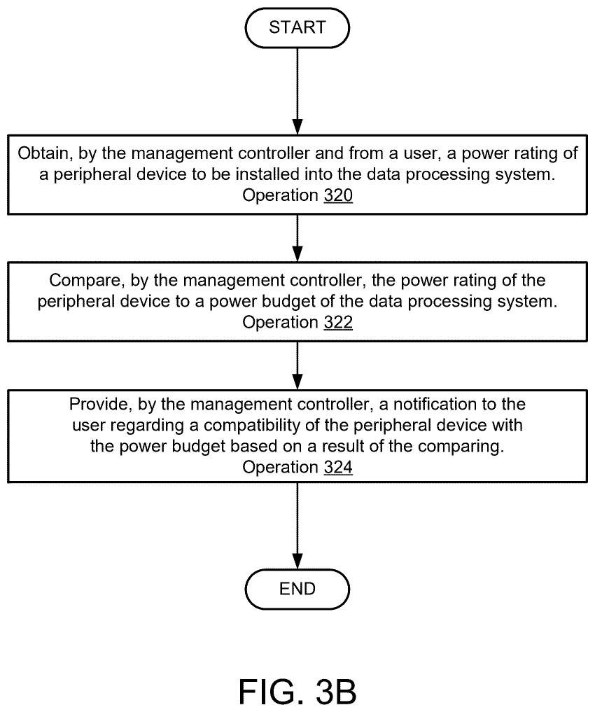

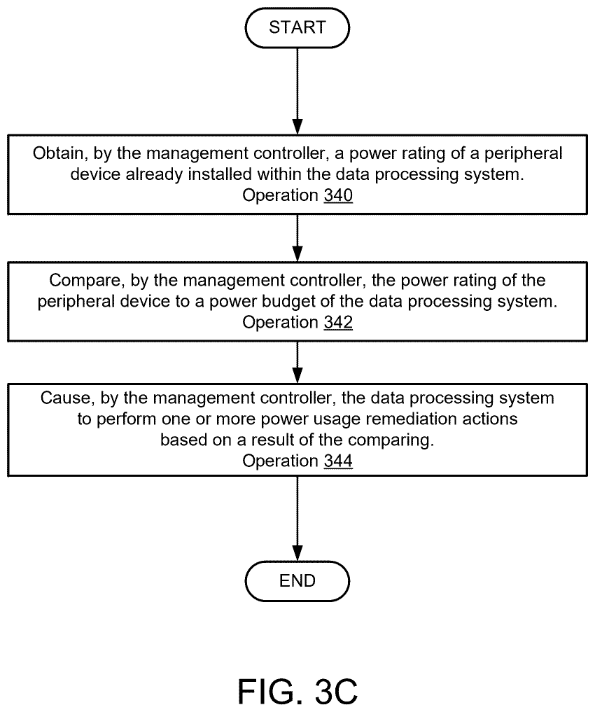

As discussed above, the components of FIGS. 1A-1C may perform various methods for managing a boot up process of a data processing system. FIGS. 3A-3C illustrate examples of methods that may be performed by the components of FIGS. 1A-1C. For example, any of the data processing systems 102A-102N and the other data processing systems 104 shown in FIG. 1A may perform all or a portion of the methods. In the diagrams discussed below and shown in FIGS. 3A-3C, any of the operations may be repeated, performed in different orders, and/or performed in parallel with or in a partially overlapping in time manner with other operations.

Starting with FIG. 3A, in Operation 300 and as discussed above in reference to FIGS. 1C and 2A, a management controller (e.g., management controller 152 of FIG. 1B) of a data processing system may obtain power data of the data processing system.

In embodiments, the power data may include input power data, output power data, and power polic (ies) of the data processing system. The power data may be obtained by a power budgeting agent (e.g., 182, FIG. 1C) of the management controller.

In Operation 302, as discussed above in reference to FIGS. 1C and 2A, the management controller may generate power usage history snapshot data (e.g., via the power budgeting agent and power usage history snapshot (e.g., 184, FIG. 1C)) using the power data.

In Operation 304, as discussed above in reference to FIGS. 2B and 2C, the management controller, may use the power usage history snapshot to control installation of one or more peripheral devices into the data processing system (described in more detail in reference to FIGS. 3B and 3C.

The method of FIG. 3A may end following operation 304.

Turning now to FIG. 3B, in Operation 320, as discussed above in reference to FIG. 2B, the management controller may obtain, from a user of the data processing system, a power rating of a peripheral device to be installed into the data processing system (e.g., included in known peripheral device power rating 220 of FIG. 2B).

In Operation 322, as discussed above in reference to FIG. 2B (namely, within the description and details of the installation recommendation generation process 222 of FIG. 2B), the management controller may compare the power rating of the peripheral device to a power budget of the data processing system.

In Operation 324, as discussed above in reference to FIG. 2B, the management controller may provide a notification (e.g., installation recommendation 224 of FIG. 2B) to the user regarding a compatibility of the peripheral device (not yet installed at this time) with the power budget based on a result of the comparing performed in Operation 322.

The method of FIG. 3B may end following operation 324.

Turning now to FIG. 3C, in Operation 340, as discussed above in reference to FIG. 2C, the management controller, may obtain a power rating of a peripheral device already installed within the data processing system.

The peripheral device may be installed in the data processing system without previously assessing whether the power rating of the peripheral device is compatible with a power budget of the data processing device.

In Operation 342, as discussed above in reference to FIG. 2C (namely, within the description and details of the power budget assessment process 244 of FIG. 2C), the management controller may compare the power rating of the peripheral device to a power budget of the data processing system.

In Operation 344, as discussed above in reference to FIG. 2C (namely, within the description and details of the power usage remediation process(es) of FIG. 2C), the management controller may cause the data processing system to perform one or more power usage remediation actions based on a result of the comparing performed in Operation 342.

In embodiments, the one or more power usage remediation actions comprises at least one action selected from a group consisting of: providing a warning to a user of the data processing system that the power rating of the peripheral device is incompatible with the power budget of the data processing system, disabling an interface between the data processing system and the peripheral device, disabling an external interface of the data processing system, and preventing completion of a startup of the data processing system. The method of FIG. 3B may end following operation 344.

Any of the components illustrated in FIGS. 1A-3C may be implemented with one or more computing devices. Turning to FIG. 4, a block diagram illustrating an example of a computing device (also referred to herein as “system 400”) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing a data processing system, the method comprising:
obtaining, by a management controller of the data processing system, power data of the data processing system, the power data comprising a total available power of the data processing system;
generating, by the management controller, a power usage history snapshot using the power data, the power usage history snapshot storing instances of the total available power of the data processing system obtained over a predetermined period of time; and
using, by the management controller, the power usage history snapshot to control installation of one or more peripheral devices into the data processing system.

2. The method of claim 1, wherein an average of the instances of the total available power of the data processing system stored in the power usage history snapshot is used as a power budget of the data processing system to control the installation of the one or more peripheral devices.

3. The method of claim 2, wherein using the power usage history snapshot to control the installation of the one or more peripheral devices into the data processing system comprises, for a peripheral device of the one or more peripheral devices and by the management controller:
obtaining a power rating of the peripheral device from a user of the data processing system, the peripheral device not yet being installed within the data processing system;
comparing the power rating of the peripheral device to the power budget; and
providing a notification to the user regarding whether the peripheral device can or cannot be installed into the data processing system without causing a power consumption issue based on a result of the comparing.

4. The method of claim 2, wherein using the power usage history snapshot to control the installation of the one or more peripheral devices into the data processing system comprises, for a peripheral device of the one or more peripheral devices and by the management controller:
obtaining a power rating of the peripheral device without user intervention, the peripheral device already being installed in the data processing system before the management controller is aware of the power rating;
comparing the power rating of the peripheral device to the power budget; and
causing the data processing system to perform one or more power usage remediation actions based on a result of the comparing.

5. The method of claim 4, wherein the one or more power usage remediation actions comprises at least one action selected from a group consisting of: providing a warning to a user of the data processing system that the power rating of the peripheral device is incompatible with the power budget of the data processing system, disabling an interface between the data processing system and the peripheral device, disabling an external interface of the data processing system, and preventing completion of a startup of the data processing system.

6. The method of claim 1, wherein the power data and the power usage history snapshot are obtained and created, respectively, using one or more daemon threads executing on the management controller.

7. The method of claim 1, wherein the management controller is a microcontroller that operates independently of a central processing unit (CPU) of the data processing system.

8. A non-transitory machine-readable medium having instructions stored therein, which when executed by a processor, cause the processor to perform operations for managing a data processing system, the operations comprising:
obtaining, by a management controller of the data processing system, power data of the data processing system, the power data comprising a total available power of the data processing system;
generating, by the management controller, a power usage history snapshot using the power data, the power usage history snapshot storing instances of the total available power of the data processing system obtained over a predetermined period of time; and
using, by the management controller, the power usage history snapshot to control installation of one or more peripheral devices into the data processing system.

9. The non-transitory machine-readable medium of claim 8, wherein an average of the instances of the total available power of the data processing system stored in the power usage history snapshot is used as a power budget of the data processing system to control the installation of the one or more peripheral devices.

10. The non-transitory machine-readable medium of claim 9, wherein using the power usage history snapshot to control the installation of the one or more peripheral devices into the data processing system comprises, for a peripheral device of the one or more peripheral devices and by the management controller:
obtaining a power rating of the peripheral device from a user of the data processing system, the peripheral device not yet being installed within the data processing system;
comparing the power rating of the peripheral device to the power budget; and
providing a notification to the user regarding whether the peripheral device can or cannot be installed into the data processing system without causing a power consumption issue based on a result of the comparing.

11. The non-transitory machine-readable medium of claim 9, wherein using the power usage history snapshot to control the installation of the one or more peripheral devices into the data processing system comprises, for a peripheral device of the one or more peripheral devices and by the management controller:
obtaining a power rating of the peripheral device without user intervention, the peripheral device already being installed in the data processing system before the management controller is aware of the power rating;
comparing the power rating of the peripheral device to the power budget; and
causing the data processing system to perform one or more power usage remediation actions based on a result of the comparing.

12. The non-transitory machine-readable medium of claim 11, wherein the one or more power usage remediation actions comprises at least one action selected from a group consisting of: providing a warning to a user of the data processing system that the power rating of the peripheral device is incompatible with the power budget of the data processing system, disabling an interface between the data processing system and the peripheral device, disabling an external interface of the data processing system, and preventing completion of a startup of the data processing system.

13. The non-transitory machine-readable medium of claim 8, wherein the power data and the power usage history snapshot are obtained and created, respectively, using one or more daemon threads executing on the management controller.

14. The non-transitory machine-readable medium of claim 8, wherein the management controller is a microcontroller that operates independently of a central processing unit (CPU) of the data processing system.

15. A data processing system, comprising:
a management controller, wherein data processing system stores instructions that causes the management controller to perform operations for managing the data processing system, the operations comprising:
obtaining power data of the data processing system, the power data comprising a total available power of the data processing system;
generating a power usage history snapshot using the power data, the power usage history snapshot storing instances of the total available power of the data processing system obtained over a predetermined period of time; and
using the power usage history snapshot to control installation of one or more peripheral devices into the data processing system.

16. The data processing system of claim 15, wherein an average of the instances of the total available power of the data processing system stored in the power usage history snapshot is used as a power budget of the data processing system to control the installation of the one or more peripheral devices.

17. The data processing system of claim 16, wherein using the power usage history snapshot to control the installation of the one or more peripheral devices into the data processing system comprises, for a peripheral device of the one or more peripheral devices and by the management controller:
obtaining a power rating of the peripheral device from a user of the data processing system, the peripheral device not yet being installed within the data processing system;
comparing the power rating of the peripheral device to the power budget; and
providing a notification to the user regarding whether the peripheral device can or cannot be installed into the data processing system without causing a power consumption issue based on a result of the comparing.

18. The data processing system of claim 16, wherein using the power usage history snapshot to control the installation of the one or more peripheral devices into the data processing system comprises, for a peripheral device of the one or more peripheral devices and by the management controller:
obtaining a power rating of the peripheral device without user intervention, the peripheral device already being installed in the data processing system before the management controller is aware of the power rating;
comparing the power rating of the peripheral device to the power budget; and
causing the data processing system to perform one or more power usage remediation actions based on a result of the comparing.

19. The data processing system of claim 18, wherein the one or more power usage remediation actions comprises at least one action selected from a group consisting of: providing a warning to a user of the data processing system that the power rating of the peripheral device is incompatible with the power budget of the data processing system, disabling an interface between the data processing system and the peripheral device, disabling an external interface of the data processing system, and preventing completion of a startup of the data processing system.

20. The data processing system of claim 15, wherein the power data and the power usage history snapshot are obtained and created, respectively, using one or more daemon threads executing on the management controller, and the management controller is a microcontroller that operates independently of a central processing unit (CPU) of the data processing system.
